(19) United States
(12) Patent Application Publication
(10) Pub. No.: US 2004/0075286 A1
(43) Pub. Date: Apr. 22, 2004

(54) Hoeing implement

(76) Inventor: Kurt W. Skowron, Pittsfield, MA (US)

Correspondence Address: LITTMAN LAW OFFICES, LTD., P.O. BOX 15035 CRYSTAL CITY STATION, ARLINGTON, VA, 22215, US

(21) Appl. No.: 10/273,846

(22) Filed: Oct. 21, 2002

(51) Int. Cl. A01B 1/08

(52) U.S. Cl. 294/58

(57) ABSTRACT

A hoeing implement for mixing concrete or mortar, or for garden hoeing, is provided with a side grip that helps in controlling the implement during use. The side grip can be loosened to allow the grip to be adjusted along the length of the shank of the implement or tightened to firmly secure the side grip onto the shank. The side grip is loosened or tightened by rotating a handle on the side grip.

### BACKGROUND OF THE INVENTION

1. Field of the Invention

The present invention relates to hoeing implements which may be used either for mixing concrete and mortar, or for gardening. More particularly, the invention is a hoeing implement having an intermediately placed side grip that is adjustable and lockable along the shank of the hoe by rotating a handle on the side grip. The side grip extends perpendicularly from the shank.

2. Description of the Related Art

Hoes are commonly used in gardening and for mixing various materials, including mortar and sand. They are typically made by attaching a blade to the end of an elongated shank. The shank is used as a handle to grip the hoe. Various styles of blades and handles are taught as well as two or more lengths of the shank, depending upon whether the hoe is used while standing or kneeling. However, a recurring problem when using a hoe is the stability of the grip and the ability of the user to move the hoe back-and-forth without losing grip.

The present invention solves this problem by providing a hoe having a perpendicularly extending side grip that can be adjustably placed on the shank between the ends of the hoe.

Side grips (i.e., grips that extend sideways from the main elongated shank of an implement) are often encountered in power tools, such as portable drills and saws, including electric and pneumatic tools. For example, portable power tools that include side grips are made by S-B Power Tool Company (Chicago, Ill.), Milwaukee Electric Tool Corporation (Brookfield, Wis.), DeWalt Company (Lancaster, Pa.), and Stanley Corporation (new Britain, Conn.). However, none of these manufacturers teach the use of a side grip specifically applied to a manually operated tool, such as the hoeing implement as taught in the present invention.

U.S. Pat. No. 1,411,435, issued to Hosmer on Apr. 4, 1922, teaches a hoe having an adjustable position, intermediate, double-D shaped handle projecting perpendicularly from the shank of the hoe and secured by thumb nuts. U.S. Pat. No. 1,945,430, issued to Garrett on Jan. 30, 1934, teaches a compound tool having a pole shaped handle and interchangeable heads, including a shovel, rake, sickle etc. The device includes a side grip extending normal to the pole handle when the tool is configured as a sickle.

U.S. Pat. No. 2,430,802, issued to Catlin on Nov. 11, 1947, teaches a shovel having a first D-shaped hand grip attached to the end of the shank and a second, intermediate, adjustable position, D-shaped hand grip extending horizontally from the shank. U.S. Pat. No. 4,477,114, issued to Callis on Oct. 16, 1984, teaches a pair of rakes, each rake having a pole handle with an intermediate hand grip extending therethrough and having an upper arm strap so that the two rakes may be manipulated together to sandwich debris between the two rakes for carrying and lifting the debris. The handgrips are not adjustable in position, as the extend through the pole handles.

None of the above inventions and patents, taken either singularly or in combination, is seen to describe the instant invention as claimed. Thus a hoeing implement tool for mixing concrete or mortar and for hoeing solving the aforementioned problems is desired.

### SUMMARY OF THE INVENTION

The hoe implement of the present invention has a side grip used to provide additional support to hold the implement during use. The hoe implement includes a blade at one end of an elongated shank and a D-shaped handgrip at the opposite end of the shank. The side grip includes a generally cylindrical handle and a split collar clamp. Moreover, the side grip extends perpendicularly from the shank and can be placed anywhere along the length of the shank by rotating the handle on the side grip to loosen the clamp and then tightened to secure firmly onto the shank by rotating the side grip handle in the opposite direction.

Accordingly, it is a principal object of the invention to provide an implement for hoeing including a side grip attached to the shank that includes a rotatable handle for tightening or loosening the side grip on the shank.

It is another object of the invention to provide an implement as described in which the side grip is adjustably to lock onto the main shank by rotating the handle.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a tool for mixing concrete or mortar and for hoeing according to the present invention.

FIG. 2 is a perspective view of the side grip of the present invention.

FIG. 3 is an exploded perspective view of the side grip of the present invention.

Similar reference characters denote corresponding features consistently throughout the attached drawings.

### DETAILED DESCRIPTION OF THE PREFERRED EMBODIMENT

The present invention is directed to a hoeing implement which is provided with an intermediate side handle. The side handle is adjustable in position along the length of the hoe shank by simply rotating the handle to loosen a split collar clamp. A rotation in one direction loosens the side handle while a rotation in the opposite direction tightens it in place.

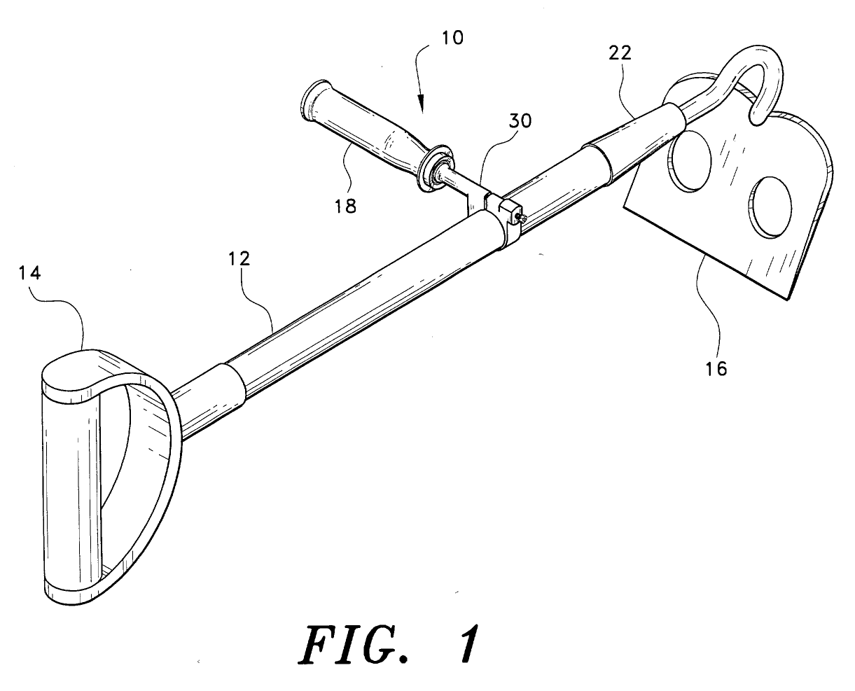

FIG. 1 shows a perspective view of the hoeing implement 10 in accordance with the present invention. The hoe includes an elongated shank 12 connected at one end to a D-shaped hand grip 14, and at the opposite end to a blade 16. The blade 16 is connected to the shank 12 by a ferrule 22. As noted in FIG. 1, the D-shaped hand grip 14 may be disposed in a plane perpendicular to the plane of the blade 16 such that the plane of the D-shaped hand grip 14 bisects the blade 16 of the hoe 10.

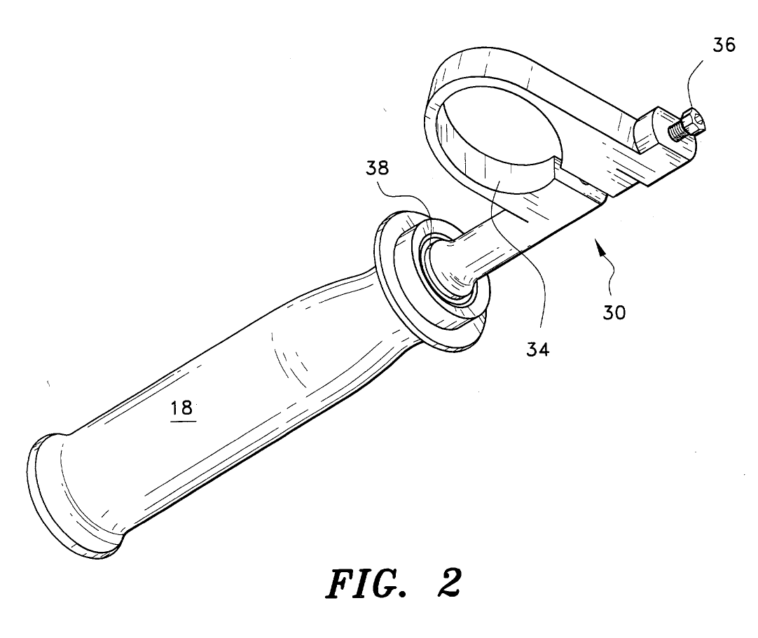

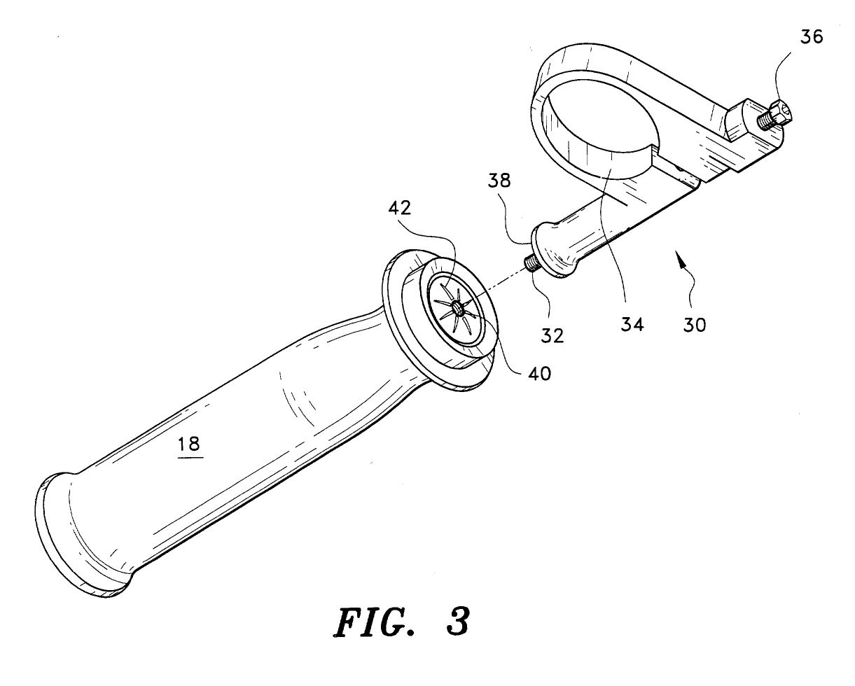

Placed intermediate the two ends of the shank 12 of the implement 10, a side grip is provided. The side grip includes a handle 18 and a split collar clamp 30. Details of the side grip are shown in FIGS. 2 and 3. The side grip includes three distinct interconnected parts: 1) the handle 18; 2) the clamp 30; and 3) the clamp bolt 36. The clamp 30 has a friction-fit opening 34 that permits the clamp to be placed onto the shank 12 of the hoe 10 as shown in FIG. 1.

The handle 18 of the side grip has an internally threaded opening 40 which the threaded end 32 of the bolt 36 engages to couple the side grip to the shank 12. The bolt 36 also extends through the ends of the split collar so that the size of the opening 34 defined by the collar may be expanded to slide the clamp on the shank, or contracted to fix the position of the side grip on the shank 12. The handle 18 of the side grip is generally cylindrical in shape, and can be rotated to tighten the handle 18 to the clamp 30, thereby seating the mating surface 42 of the handle with the corresponding surface 38 of the clamp 30, and causing the clamp 30 to firmly grip the shank 12 of the hoe 10. The size of the friction-fit opening 34 of the clamp 30 corresponds with the outer diameter of the hoe shank 12.

The handle 18 can also be rotated to loosen the clamp from the shank and thereby allow the clamp to be placed at any suitable location along the shank.

It is noted that the length of the shank 12 of the hoe can vary between a shortened version for use while kneeling, or a long version for use while standing. In a preferred embodiment, the length of the shank is about twenty inches, and the side grip is positioned about halfway between the D-shaped grip 14 and the blade 16. In this configuration, the hoe 10 may be used for pre-mixing concrete or mortar while kneeling down, rather than the conventional method of standing up while mixing the concrete. The combination of the short shank length, the D-shaped grip at the end of the shank oriented in a plane perpendicular to the plane of the blade and which bisects the blade, and the cylindrical side grip handle provides greater control of the hoe blade 16, resulting in faster, neater mixing of the material, as well as less strain on the low back muscles and wrists.

It is to be understood that the present invention is not limited to the embodiment described above, but encompasses any and all embodiments within the scope of the following claims.

I claim:

1. A hoeing implement, comprising:
an elongated shank having a first end and a second end;
a D-shaped hand grip attached to the first end of said shank;
a planar hoe blade attached to the second end of said shank; and
a side grip having a substantially cylindrical handle extending normal to said shank intermediate the first and second ends of said shank.

2. The hoeing implement according to claim 1, wherein said side grip further includes:
a split collar having opposing ends;
a bolt having a threaded shaft extending through the ends of the split collar; and
wherein the cylindrical handle has an end having an internally threaded bore defined therein, the collar being disposed about said shank and said bolt engaging the internally threaded bore defined in said handle;
whereby said side grip is adjustable vertically and radially on said shank by rotating said handle to loosen and tighten the collar.

3. The hoeing implement according to claim 2, wherein said shank has a length of about twenty inches, the hoeing implement being adapted for use in a kneeling position.

4. The hoeing implement according to claim 2, wherein said D-shaped grip is disposed in a first plane perpendicular to a second plane in which said hoe blade is disposed, the first plane bisecting said hoe blade.

5. A hoeing implement, comprising:
an elongated shank having a first end and a second end;
a D-shaped hand grip attached to the first end of said shank;
a planar hoe blade attached to the second end of said shank; and
a side grip having:
a substantially cylindrical handle-extending normal to said shank intermediate the first and second ends of said shank, the handle having an end with an internally threaded bore defined therein;
a split collar having opposing ends, the collar being disposed about said shank;
a bolt having a threaded shaft extending through the ends of the split collar and engaging the bore defined in the handle, whereby said side grip is adjustable vertically and radially on said shank by rotating said handle to loosen and tighten the collar.

6. The hoeing implement according to claim 5, wherein said shank has a length of about twenty inches, the hoeing implement being adapted for use in a kneeling position.

7. The hoeing implement according to claim 5, wherein said D-shaped grip is disposed in a first plane perpendicular to a second plane in which said hoe blade is disposed, the first plane bisecting said hoe blade.
